(19) United States
(12) Patent Application Publication
(10) Pub. No.: US 2010/0055467 A1
(43) Pub. Date: Mar. 4, 2010

(54) COATING COMPOSITIONS COMPRISING THE REACTION PRODUCT OF A BIOMASS DERIVED POLYOL AND A LACTIDE

(75) Inventors: Jackie L. Kulfan, Valencia, PA (US); David R. Fenn, Allison Park, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/202,801

(22) Filed: Sep. 2, 2008

(51) Int. Cl. C09D 131/02; B32B 9/04; B32B 27/34; B32B 27/36; B32B 15/04

(52) U.S. Cl. 428/412; 524/560; 428/411.1; 428/475.5; 428/457

(57) ABSTRACT

A coating comprising the reaction product of a biomass derived polyol and a lactide are disclosed. Substrates coated at least in part with these coatings are also disclosed.

### FIELD OF THE INVENTION

The present invention is directed to a coating comprising the reaction product of a biomass derived polyol and a lactide.

### BACKGROUND OF THE INVENTION

The price of raw materials used in many manufacturing processes continues to rise, particularly those whose price rises or falls with the price of oil. Because of this, and because of the predicted depletion of oil reserves, raw materials derived from renewable resources or alternative resources may be desired. An increase in demand for environmentally friendly products, together with the uncertainty of the variable and volatile petrochemical market, has promoted the development of raw materials from renewable and/or inexpensive sources.

### SUMMARY OF THE INVENTION

The present invention is directed to a coating comprising the reaction product of a) a biomass derived polyol; and b) a lactide.

### DETAILED DESCRIPTION OF THE INVENTION

The present invention is directed to a coating comprising the reaction product of a biomass derived polyol and a lactide, which is sometimes referred to herein as the “polyol/lactide reaction product” or like terms. A biomass derived polyol (also referred to sometimes herein as “biobased polyol”) is any polyol that is derived directly from biomass or that is prepared from one or more biomass derived compounds. A biomass derived compound will be understood to be a compound derived from a living or recently living organism for example, plants (including trees) or animals, and not from a petroleum based source.

Any suitable biomass derived polyol can be used according to the present invention. Suitable polyols can have a number average molecular weight as determined by GPC (“Mn”) of 500 to 100,000, such as 500 to 10,000. In certain embodiments, the polyol can have a hydroxyl value of 20 to 400, such as 40 to 300, or 120 to 350. In certain other embodiments, the hydroxyl value can range from 1200 to 2100, such as 1400 to 1900. The polyols can be derived from natural oils such as castor oil, peanut oil, soy bean oil or canola oil. The hydroxyl groups present in the biomass derived polyols can be naturally occurring or they can be introduced, for example, by modification of carbon-carbon double bonds present in the oils. Natural oil derived polyols are described in United States Patent Publication Number 2006/0041156 A1, U.S. Pat. No. 7,084,230, WO 2004/096882 A1, U.S. Pat. No. 6,686,435, U.S. Pat. No. 6,107,433, U.S. Pat. No. 6,573,354 and U.S. Pat. No. 6,433,121, all of which are incorporated in their entirety herein. Methods of modifying carbon-carbon double bonds to introduce hydroxyl groups include treatment with ozone, air oxidation, reaction with peroxides or hydroformylation (as described in “Polyols and Polyurethanes from Hydroformylation of Soybean Oil”, Journal of Polymers and the Environment, Volume 10, Numbers 1-2, pages 49-52, April, 2002, incorporated herein in its entirety). A particularly suitable biomass derived polyol is a soy polyol. Soy polyols are commercially available from Cargill Inc., Urethane Soy Systems Co. and BioBased Technologies Inc. The biomass derived polyol can also comprise recycled polyester, for example recycled polyethylene terephthalate (PET). Biomass derived polyols can be obtained by reacting recycled PET with polyols, for example soy polyol and glycerol, under conditions that lead to transesterification.

When soy polyols and other biomass derived polyols are used in coatings, such coatings tend to have reduced hardness, solvent resistance, resistance to chemicals, for example those found in skin lotions, sun protection creams and insect repellents and/or degradation of other properties as compared to coatings having petroleum based polyols. This is believed to be due to the low glass transition temperature (“Tg”) and the low reactivity of the secondary hydroxyl groups present in such polyols. The present inventors have discovered that the reaction product obtained by reacting a biomass derived polyol with a lactide provides improved properties when used in coatings, as compared to use in coatings of unmodified biomass derived polyols.

Any suitable lactide can be used according to the present invention, such as L-lactide, meso-lactide or D-lactide. Mixtures of any of the isomers can also be used. Lactide is the cyclic diester of lactic acid (2-hydroxypropionic acid). Suitable lactides are also commercially available. In certain embodiments, the lactide can also be biomass derived.

In certain embodiments, biomass derived polyol can be reacted with lactide and one or more other cyclic monomers, such as caprolactone. These reactions can be carried out simultaneously or in sequence.

The reaction between the lactide and the biobased polyol can be carried out under any suitable conditions. For example, the polyol and lactide can be mixed and heated to a temperature of 100-200° C., such as 120-150° C., for a period of two to ten hours. The reaction can be carried out in the presence of a catalyst, for example complexes of tin, aluminum, zinc and lanthanides. Tin compounds such as tin(II) 2-ethylhexanoate are particularly suitable. The reaction can be carried out in bulk or in the presence of solvent(s).

The molar ratio of hydroxyl groups from the biomass derived polyol to lactide can be 1:0.1 to 1:10, such as 1:0.2 to 1:6, or 1:0.5 to 1:3. The polyol/lactide reaction product can have a hydroxyl value of 20 to 400, such as 40 to 350, or 80 to 220, and can have an Mn of 500 to 1 00,000, such as 750 to 1 0,000, or 1 000 to 7500.

In certain embodiments, 40% or greater, such as 60% or greater, or 80% or greater of the carbon content of the polyol/lactide reaction product originates directly from biomass. It will be appreciated that combinations of biomass derived polyols and/or combinations of biomass derived lactides can be used, and that the polyol and lactide need not be derived from the same type of biomass.

The coatings of the present invention can comprise 2 to 100 weight %, such as 20 to 85 or 30 to 70 weight %, or any combination of numbers in these ranges, of the polyol/lactide reaction product, with weight % based on total solids weight of the coating.

In certain embodiments, the coatings of the present invention are thermoplastic, while in other embodiments they are thermosetting. Thermosetting compositions may comprise components that crosslink with themselves, i.e. self-crosslinking, or may comprise a crosslinker that will react with the polyol/lactide reaction product. Suitable crosslinkers include, for example, polyisocyanates and aminoplasts.

Suitable polyisocyanates include multifunctional isocyanates. Examples of multifunctional polyisocyanates include aliphatic diisocyanates like hexamethylene diisocyanate and isophorone diisocyanate, and aromatic diisocyanates like toluene diisocyanate and 4,4′-diphenylmethane diisocyanate. The polyisocyanates can be blocked or unblocked. Examples of other suitable polyisocyanates include isocyanurate trimers, allophanates, and uretdiones of diisocyanates and polycarbodiimides, such as those disclosed in U.S. patent application Ser. No. 12/056,306 filed Mar. 27, 2008, incorporated by reference in its entirety herein. Suitable polyisocyanates are well known in the art and are widely available commercially. For example, suitable polyisocyanates are disclosed in U.S. Pat. No. 6,316,119 at columns 6, lines 19-36, incorporated by reference herein. Examples of commercially available polyisocyanates include DESMODUR N3390, which is sold by Bayer Corporation and TOLONATE HDT90, which is sold by Rhodia Inc.

Suitable aminoplasts include condensates of amines and or amides with aldehyde. For example, the condensate of melamine with formaldehyde is a suitable aminoplast. Suitable aminoplasts are well known in the art. A suitable aminoplast is disclosed, for example, in U.S. Pat. No. 6,316,119 at column 5, lines 45-55, incorporated by reference herein.

When a crosslinker is used, the coatings of the present invention can comprise 5 to 60 weight %, such as 10 to 50, or 20 to 40 weight % of crosslinker, based on total solids weight of the coating.

It will be appreciated that when the present polyol/lactide reaction product is used in a coating according to the present invention, it can form all or part of the film-forming resin of the coating. In certain embodiments, one or more additional film-forming resins are also used in the coating. For example, the coating compositions can comprise any of a variety of thermoplastic and/or thermosetting compositions known in the art. The coating compositions may be water based or solvent based liquid compositions, or, alternatively, may be in solid particulate form, i.e., a powder coating.

Thermosetting or curable coating compositions typically comprise film-forming polymers or resins having functional groups that are reactive with either themselves or a crosslinking agent. The additional film-forming resin can be selected from, for example, acrylic polymers, polyester polymers, polyurethane polymers, polyamide polymers, polyether polymers, polysiloxane polymers, copolymers thereof, and mixtures thereof. Generally these polymers can be any polymers of these types made by any method known to those skilled in the art. Such polymers may be solvent borne or water dispersible, emulsifiable, or of limited water solubility. The functional groups on the film-forming resin may be selected from any of a variety of reactive functional groups including, for example, carboxylic acid groups, amine groups, epoxide groups, hydroxyl groups, thiol groups, carbamate groups, amide groups, urea groups, isocyanate groups (including blocked isocyanate groups) mercaptan groups, and combinations thereof.

If additional thermosetting coating compositions are used, they may be self-crosslinking, that is, they may have functional groups that are reactive with themselves, or a crosslinking agent may be added. If a crosslinker is used to react with the polyol/lactide reaction product, the thermosetting resin may be selected so as to be reactive with the same crosslinker. Any of the crosslinking agents described above can be used. Other crosslinking agents can be used such as polyepoxides, beta hydroxylalkylamides, polyacids, and hydrides, organometallic acid-functional materials, polyamines, polyamides, and mixtures of any of these.

Appropriate mixtures of film-forming resins may also be used in the preparation of the coating compositions.

In a particularly suitable embodiment, the coating composition comprises one or more additional film-forming resins that comprise the reaction product of a polyol and lactide. The polyol can be a small molecule containing more than one hydroxyl group, for example neopentyl glycol or pentraerythritol, or it can be a polymeric polyol such as a polyester polyol or an acrylic polyol. Acrylic polyols are particularly suitable.

The coating compositions of the present invention may also include a solvent and/or reactive diluent in one or more of the components. The coatings can also be 100% solids. Suitable solvents include water, organic solvent(s) and/or mixtures thereof. Suitable organic solvents include glycols, glycol ether alcohols, alcohols, ketones, and aromatics, such as xylene and toluene, acetates, mineral spirits, naphthas and/or mixtures thereof. “Acetates” include the glycol ether acetates. The solvents can be biomass derived. Examples of biomass derived solvents include esters of lactic acid and esters of soybean oil fatty acid. In certain embodiments, the solvent is a non-aqueous solvent. “Non-aqueous solvent” and like terms means that less than 50 percent of the solvent is water. For example, less than 10 percent, or even less than 5 percent of the solvent can be water. It will be understood that mixtures of solvents, including or excluding water in an amount of less than 50 percent, can constitute a “non-aqueous solvent”. In other embodiments, the coating is aqueous or water-based. This means that 50% or more of the solvent is water. These embodiments have less than 50%, such as less than 20%, less than 10%, less than 5%, or less than 2% solvent.

If desired, the coating compositions can comprise other optional materials well known in the art of formulating coatings in any of the components, such as colorants, plasticizers, abrasion resistant particles, anti-oxidants, hindered amine light stabilizers, UV light absorbers and stabilizers, surfactants, flow control agents, antifoaming agents, wetting agents, thixotropic agents, fillers, waxes, lubricants, fortifiers, stabilizers, organic cosolvents, reactive diluents, catalysts, grind vehicles, and other customary auxiliaries.

An “abrasion resistant particle” is one that, when used in a coating, will impart some level of abrasion resistance to the coating as compared with the same coating lacking the particles. Suitable abrasion resistant particles include organic and/or inorganic particles. Examples of suitable organic particles include but are not limited to diamond particles, such as diamond dust particles, and particles formed from carbide materials; examples of carbide particles include but are not limited to titanium carbide, silicon carbide and boron carbide. Examples of suitable inorganic particles, include but are not limited to silica; alumina; alumina silicate; silica alumina; alkali aluminosilicate; borosilicate glass; nitrides including boron nitride and silicon nitride; oxides including titanium dioxide and zinc oxide; quartz; nepheline syenite; zircon such as in the form of zirconium oxide; buddeluyite; and eudialyte. Particles of any size can be used, as can mixtures of different particles and/or different sized particles. For example, the particles can be microparticles, having an average particle size of 0.1 to 50, 0.1 to 20, 1 to 12, 1 to 10, or 3 to 6 microns, or any combination within any of these ranges. The particles can be nanoparticles, having an average particle size of less than 0.1 micron, such as 0.8 to 500, 10 to 100, 100 to 500 nanometers, or any combination within these ranges.

As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemicals, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference in its entirety. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference in its entirety, United States Patent Application Publication Number 2005-0287348 A1, filed Jun. 24, 2004, and United States Patent Application Publication Number 2006-0251897, filed Jan. 20, 2006, which are also incorporated herein by reference in their entirety.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference in its entirety. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. patent application Ser. No. 10/892,919 filed Jul. 16, 2004, and incorporated herein by reference in its entirety.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

It will be appreciated by those skilled in the art that the biomass derived polyol will react with the lactide to form a polyol containing poly(lactic acid) units. In certain embodiments, the coatings of the present invention comprise 5 weight % or greater poly(lactic acid) units derived from lactide, such as 10 weight % or greater, or 30 weight % or greater, with weight % based on total solid weight. In certain embodiments, 10 weight % or greater, such as 20 weight % or greater, or 50 weight % or greater, of the carbon content of the coating composition originates directly from biomass, with weight % based on total solid weight.

It will be appreciated that the coatings described herein can be either one component (“1K”), or multi-component compositions such as two component (“2K”). A 1K composition will be understood as referring to a composition wherein all the coating components are maintained in the same container after manufacture, during storage, etc. A 1K coating can be applied to a substrate and cured by any conventional means, such as by heating, forced air, and the like. The present coatings can also be 2K coatings or multi-component coatings, which will be understood as coatings in which various components are maintained separately until just prior to application. As noted above, the present coatings can be thermoplastic or thermosetting.

The present coatings can be applied to any substrate known in the art, for example automotive substrates and industrial substrates. These substrates can be, for example, metallic or non-metallic, including polymeric, plastic, polycarbonate, polycarbonate/acrylobutadiene styrene (“PC/ABS”), polyamide, wood, veneer, wood composite, particle board, medium density fiberboard, cement, stone, and the like. In a particularly suitable embodiment of the present invention, the substrate itself is biodegradable. Biodegradable substrates include, for example paper, wood and biodegradable plastics such as cellulose, poly(lactic acid), poly(3-hydroxybutyrate) and starch based plastics. In addition, the substrate can be one that has been recycled. The substrate can also be one that has already been treated in some manner to impart color or other visual effect. For example, a wood substrate that has been stained may then be coated according to the present invention, as can a substrate that has already had one or more other coating layers applied to it.

As used herein, the term “polyamide substrate” refers to a substrate constructed from a polymer that includes repeating units of the formula:

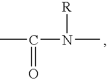

wherein R is hydrogen or an alkyl group. The polyamide may be any of a large class of polyamides based on aliphatic, cycloaliphatic, or aromatic groups in the chain. They may be formally represented by the products of condensation of a dibasic amine with a diacid and/or diacid chloride, by the product of self-condensation of an amino acid, such as omega-aminoundecanoic acid, or by the product of a ring-opening reaction of a cyclic lactam, such as caprolactam, lauryllactam, or pyrrolidone. They may contain one or more alkylene, arylene, or aralkylene repeating units. The polyamide may be crystalline or amorphous. In certain embodiments, the polyamide substrate comprises a crystalline polyamide of alkylene repeating units having from 4 to 12 carbon atoms, such as poly(caprolactam) (nylon 6), poly(lauryllactam) (nylon 12), poly(omega-aminoundecanoic acid) (nylon 11), poly(hexamethylene adipamide) (nylon 6.6), poly(hexamethylene sebacamide) (nylon 6.10), and/or an alkylene/arylene copolyamide, such as that made from meta-xylylene diamine and adipic acid (nylon MXD6). The term “nylon” includes all of these products as well as any other compound referred to in the art as nylon. Amorphous polyamides, such as those derived from isophoronediamine or trimethylcyclohexanediamine, may also be utilized. Blends of polyamides may also be utilized.

As used herein, the term “polyamide”, when used in reference to a substrate, includes a reinforced polyamide substrate; a reinforced polyamide substrate is a polyamide substrate constructed from a polyamide that has been reinforced through the inclusion of, for example, fibrous materials, such as glass fiber or carbon fiber, or inorganic fillers, such as calcium carbonate, to produce a polyamide having increased rigidity, strength, and/or heat resistance relative to a similar polyamide that does not include such reinforcing materials. Reinforced polyamides, which are suitable for use as a substrate material in accordance with certain embodiments of the present invention, are commercially available and include, for example, those materials commercially available from Solvay Advanced Polymers under the IXEF name and, include, for example, the IXEF 1000, 1500, 1600, 2000, 2500, 3000 and 5000 series products; from EMS-Chemie Inc., Sumter, S.C., under the GRILAMID, GRIVORY, GRILON and GRILFLEX tradenames; and DuPont Engineered Polymers, such as those sold under the THERMX and MINLON tradenames.

The coatings of the present invention can be applied by any means standard in the art, such as electrocoating, spraying, electrostatic spraying, dipping, rolling, brushing, and the like.

The coatings can be applied to any dry film thickness, such as 0.1 to 4 mils, 0.3 to 2 or 0.7 to 1.3 mils. The coatings of the present invention can be used alone, or in combination with other coatings. For example, the coating can comprise a colorant or not and can be used as a primer, ecoat, basecoat, top coat, automotive repair coat, and the like. For substrates coated with multiple coatings, one or more of those coatings can be coatings as described herein. In certain embodiments, a coating according to the present invention is used as a clearcoat and may further be used in conjunction with (i.e. on top of at least a portion of) a basecoat that may comprise a colorant and that comprises the reaction product of an active hydrogen containing compound and a lactide wherein the ratio by weight of active hydrogen containing compound to lactide is 1:>10 to 1:10,000, such as 1:>10 to 1:5000 or 1:50 to 1:400. Such a reaction product is described in U.S. patent application Ser. No. 12/202,755 entitled “Crosslinked Coatings Comprising Lactide” filed on even date herewith, and incorporated by reference herein in its entirety.

As used herein, unless otherwise expressly specified, all numbers such as those expressing values, ranges, amounts or percentages may be read as if prefaced by the word “about”, even if the term does not expressly appear. Also, any numerical range recited herein is intended to include all subranges subsumed therein. Singular encompasses plural and vice versa. For example, although reference is made herein, including the claims, to “a” biomass derived polyol, “a” lactide, “a” polyol/lactide reaction product, “a” crosslinker, and the like, one or more of any of these compounds can be used. “Including” means “including, but not limited to”. As used herein, the term “polymer” refers to oligomers and both homopolymers and copolymers, and the prefix “poly” refers to two or more.

### EXAMPLES

The following examples are intended to illustrate the invention, and should not be construed as limiting the invention in any way.

### Example 1

### Soy Polyol/Lactide Adduct—1:2 OH:Lactide Ratio

| | Component | Mass (/g) |
|---|---|---|
| 1 | BiOH 1560¹ | 102.49 |
| 2 | Toluene | 23.98 |
| 3 | DL-Lactide² | 122.17 |
| 4 | Stanous octoate | 0.34 |
| 5 | Toluene | 1.02 |

¹Soy polyol available from Cargill, Incorporated, hydroxyl value 232 mg KOH/g.
²Available from Nature Works LLC.

Components 1, 2 and 3 were charged to a flask fitted with a stirrer, nitrogen inlet, thermocouple and toluene filled Dean and Stark condenser. The mixture was raised to reflux, held for 15 minutes and then cooled to 80° C. Components 4 and 5 were added and the temperature was increased to 125° C. and maintained for eight hours, solvent being drained from the Dean and Stark condenser if reflux occurred at a lower temperature. The reaction product had a solids content of 98.9% and a number average molecular weight of 2400.

### Example 2

### Soy Polyol/Lactide Adduct—1:2 OH:Lactide Ratio

| | Component | Mass (/g) |
|---|---|---|
| 1 | BiOH 1560 | 546.59 |
| 2 | Toluene | 127.87 |
| 3 | DL-Lactide | 651.58 |
| 4 | Stanous octoate | 1.83 |
| 5 | Toluene | 5.47 |
| 6 | Methyl amyl ketone | 166.67 |

Components 1 and 2 were charged to a flask fitted with a stirrer, nitrogen inlet, thermocouple and toluene filled Dean and Stark condenser. The mixture was raised to reflux, held for 15 minutes and then cooled to 80° C. Components 3, 4 and 5 were added and the temperature was increased to 125° C. and maintained for eight hours, solvent being drained from the Dean and Stark condenser if reflux occurred at a lower temperature. Component 6 was then added. The reaction product had a solids content of 82.1% and a number average molecular weight of 2550.

### Example 3

### Lactide Modified Acrylic Polyol—1:0.5 OH:Lactide Ratio

| | Component | Mass (/g) |
|---|---|---|
| 1 | Butyl acetate | 150.33 |
| 2 | Styrene | 61.78 |
| 3 | Methyl methacrylate | 41.19 |
| 4 | Butyl acrylate | 30.89 |
| 5 | Hydroxyethyl methacrylate | 72.08 |
| 6 | t-dodecyl mercaptan | 4.12 |
| 7 | VAZO 67³ | 8.24 |
| 8 | Butyl acetate | 41.19 |
| 9 | LUPEROX 26M50⁴ | 1.03 |
| 10 | Butyl acetate | 4.12 |
| 13 | Stanous octoate | 0.04 |
| 14 | DL-Lactide | 39.91 |
| 15 | Butyl acetate | 39.95 |

³2,2′-azobis(2-methylbutyronotrile), available from Du Pont Specialty Chemicals.
⁴50% t-butyl peroctoate in mineral spirits, available from Arkema Inc.

Component 1 was raised to reflux in a flask fitted with a stirrer, thermocouple, nitrogen inlet and condenser. The temperature was adjusted throughout the process to maintain reflux until noted otherwise. Components 2-8 were added at a uniform rate over 180 minutes. After a further 30 minutes, components 9 and 10 were added over 10 minutes. 30 minutes later, components 11 and 12 were added over 10 minutes. Reflux was maintained for 60 minutes and then the temperature was reduced to 90° C. Components 13 and 14 were added and the temperature was increased to 125° C. and maintained for 8 hours. Finally component 15 was added. The reaction product had a solids content of 55.3% and a number average molecular weight of 2850.

### Example 4

### Lactide Modified Acrylic Polyol—1:1 OH:Lactide Ratio

| | Component | Mass (/g) |
|---|---|---|
| 1 | Butyl acetate | 122.84 |
| 2 | Styrene | 50.48 |
| 3 | Methyl methacrylate | 16.83 |
| 4 | Butyl acrylate | 30.29 |
| 5 | Hydroxyethyl methacrylate | 70.68 |
| 6 | t-dodecyl mercaptan | 3.37 |
| 7 | VAZO 67 | 6.73 |
| 8 | Butyl acetate | 33.66 |
| 9 | LUPEROX 26M50 | 0.84 |
| 10 | Butyl acetate | 3.37 |
| 13 | Stanous octoate | 0.08 |
| 14 | DL-Lactide | 78.28 |
| 15 | Butyl acetate | 78.35 |

Component 1 was raised to reflux in a flask fitted with a stirrer, thermocouple, nitrogen inlet and condenser. The temperature was adjusted throughout the process to maintain reflux until noted otherwise. Components 2-8 were added at a uniform rate over 180 minutes. After a further 30 minutes, components 9 and 10 were added over 10 minutes. 30 minutes later, components 11 and 12 were added over 10 minutes. Reflux was maintained for 60 minutes and then the temperature was reduced to 90° C. Components 13 and 14 were added and the temperature was increased to 125° C. and maintained for 8 hours. Finally component 15 was added. The reaction product had a solids content of 53.6% and a number average molecular weight of 2900.

### Example 5

### Soy Polyol/Lactide Adduct—1:1 OH:Lactide Ratio

| | Component | Mass (/g) |
|---|---|---|
| 1 | BiOH 1560 | 140.83 |
| 2 | DL-Lactide | 83.94 |
| 3 | Toluene | 23.59 |
| 4 | Stanous octoate | 0.24 |
| 5 | Toluene | 1.41 |

Components 1-3 were charged to a flask fitted with a stirrer, nitrogen inlet, thermocouple and toluene filled Dean and Stark condenser. The mixture was raised to reflux, held for 15 minutes and then cooled to 80° C. Components 4 and 5 were added and the temperature was increased to 125° C. and maintained for eight hours, solvent being drained from the Dean and Stark condenser if reflux occurred at a lower temperature. The reaction product has a solids content of 95.0% and a number average molecular weight of 2000.

### Example 6

A coating composition for comparative purposes (“C1”) and a coating of the present invention (“present coating”) were prepared using the ingredients and amounts (in grams) shown in Table 1. All ingredients except isocyanate were weighed together in a 2 oz jar and shaken for 10 minutes to combine. The isocyanate was added and hand stirred until homogenous. The formulated paint was then applied to a cold rolled steel panel. The application method was a draw down with a #58 wirewound coil bar. The panels were flashed at ambient temperature for 10 minutes and then baked for 30 minutes at 180° F.

The final films were 2.2 mils to 2.7 mils in thickness.

TABLE 1

| Material | C1 Coating | Present Coating |
|---|---|---|
| BiOH 1560 | 8.33 | — |
| Resin of example 1 | — | 11.07 |
| 10% Dibutyl tin dilaurate | 0.3 | 0.3 |
| Methyl ethyl ketone⁵ | 3.99 | 4.16 |
| DESMODUR N 3390A BA/SN⁶ | 7.39 | 4.47 |

Testing

| | | |
|---|---|---|
| Pencil Hardness (ASTM D3363) | 2B | HB |
| MEK Resistance⁷ | Minor | Minor Scratches |
| | Scratches | |

⁵10% by weight dibutyl tin dilaurate in methyl amyl ketone.
⁶Polymeric Hexamethylene diisocyanate, 90% by weight in organic solvent, available from Bayer Material Science, LLC.
⁷MEK soaked cotton swab rubbed 100 times (back and forth = 1 rub).

These results demonstrate that replacement of a soy polyol with a lactide modified soy polyol leads to improved hardness in both isocyanate and melamine crosslinked coatings.

### Example 7

A coating composition for comparative purposes (“C2”) and a coating of the present invention (“present coating”) were prepared using the ingredients and amounts (in grams) shown in Table 2. All ingredients were weighed together in a 4 oz can and shaken for 15 minutes to combine. The formulated paint was then applied to a cold rolled steel panel. The application method was a draw down with a #50 wirewound coil bar. The panels were flashed at ambient temperature for 10 minutes and then baked for 30 minutes at 250° F.

The final films were 1.5 mils to 2.3 mils in thickness.

TABLE 2

| | | Present |
|---|---|---|
| Material | C2 Coating | Coating |
| BiOH 1560 | 29.80 | — |
| Resin of example 5 | — | 31.34 |
| CYMEL 303⁸ | 12.77 | 12.75 |
| Dodecylbenzene sulfonic acid (70% solids in | 0.46 | 0.46 |
| isopropanol) | | |
| Methyl ethyl ketone | 16.98 | 15.45 |

Testing

| | | |
|---|---|---|
| Pencil Hardness (ASTM D3363) | 2B | HB |
| MEK Resistance | Untouched | Untouched |
| Impact resistance (in-lbs)⁹ | 100/40 | 160/140 |
| (Direct Impact/Reverse Impact) | | |

⁸Hexamethyoxymethylmelamine, available from Cytec Industries, Inc.
⁹Falling dart impacter, ⅝″ dart.

These results demonstrate that replacement of a soy polyol with a lactide modified soy polyol leads to improved hardness in both isocyanate and melamine crosslinked coatings.

### Examples 8 and 9

Coating compositions were prepared using the ingredients and amounts (in grams) shown in Table 3. All ingredients except isocyanate were weighed together in a jar and shaken for 10 minutes to combine. The isocyanate was added and hand stirred until homogenous. The formulated paint was then applied to a cold rolled steel panel. The application method was a draw down with a #58 wirewound coil bar. The panels were flashed at ambient temperature for 10 minutes and then baked for 30 minutes at 180° F.

The final films were 2.2 mils to 2.4 mils in thickness.

TABLE 3

| Material | Ex 8 | Ex 9 |
|---|---|---|
| Resin of example 2 | 6.19 | 6.21 |
| Resin of example 3 | 15.92 | — |
| Resin of example 4 | — | 16.51 |
| 10% Dibutyl tin dilaurate | 0.40 | 0.41 |
| Methyl ethyl ketone | 1.34 | 0.78 |
| DESMODUR N 3390A BA/SN | 6.24 | 6.16 |

Testing

| | | |
|---|---|---|
| Konig Hardness (seconds) | 142 | 147 |
| Gasoline Resistance¹⁰ | No effect | No effect |

¹⁰Gasoline soaked cotton swab rubbed 100 times (back and forth = 1 rub).

These examples demonstrate that coatings comprising both a lactide modified soy polyol and a lactide modified acrylic copolymer have acceptable Konig hardness and gasoline resistance.

Whereas particular embodiments of this invention have been described above for purposes of illustration, it will be evident to those skilled in the art that numerous variations of the details of the present invention may be made without departing from the invention as defined in the appended claims.

Therefore we claim:

1. A coating comprising the reaction product of:
a) a biomass derived polyol; and
b) a lactide.

2. The coating of claim 1, wherein the biomass derived polyol comprises soy polyol.

3. The coating of claim 1, wherein the lactide comprises biomass derived lactide.

4. The coating of claim 1, wherein the hydroxyl value of the reaction product is 40 to 350.

5. The coating of claim 1, wherein the hydroxyl value of the reaction product is 80 to 220.

6. The coating of claim 1, wherein the Mn is 750 to 10,000.

7. The coating of claim 1, wherein the Mn is 1000 to 7500.

8. The coating of claim 1, wherein 40 weight % or greater of the carbon content of the reaction product is from biomass derived material, with weight % based on total solids weight of the coating.

9. The coating of claim 1, wherein 60 weight % or greater of the carbon content of the reaction product is from biomass derived material, with weight % based on total solids weight of the coating.

10. The coating of claim 1, wherein 80 weight % or greater of the carbon content of the reaction product is from biomass derived material, with weight % based on total solids weight of the coating.

11. The coating of claim 1, wherein the coating comprises 20 to 85 weight % of the reaction product, with weight % based on total solids weight of the coating.

12. The coating of claim 1, wherein the coating comprises 30 to 70 weight % of the reaction product, with weight % based on total solids weight of the coating.

13. The coating of claim 1, further comprising a crosslinker.

14. The coating of claim 1, further comprising an additional film-forming resin that is the reaction product of a polyol and a lactide.

15. The coating of claim 14, wherein the polyol is an acrylic polyol.

16. A substrate coated at least in part with the coating of claim 1.

17. The substrate of claim 16, wherein the substrate is non-metallic.

18. The substrate of claim 16, wherein the substrate is polymeric.

19. The substrate of claim 16, wherein the substrate is nylon.

20. The substrate of claim 16, wherein the substrate is PC/ABS.

21. The substrate of claim 16, wherein the substrate is biodegradable.

22. The substrate of claim 16, wherein the substrate is metallic.

23. The substrate of claim 16, wherein the coating is a clearcoat and is used in conjunction with a basecoat comprising a reaction product of a compound containing two or more active hydrogen groups and a lactide, wherein the ratio by weight of the compound containing two or more active hydrogen groups to lactide is 1:>10 to 1:10,000.

24. The substrate of claim 23, wherein the ratio is 1:50 to 1:400.
